(19) United States
(12) Patent Application Publication
(10) Pub. No.: US 2015/0046321 A1
(43) Pub. Date: Feb. 12, 2015

(54) SYSTEM FOR COLLECTORLESS COLLECTIONS

(71) Applicant: BillFloat, Inc., San Francisco, CA (US)

(72) Inventors: Sean O'Malley, San Francisco, CA (US); Ryan Gilbert, San Francisco, CA (US)

(21) Appl. No.: 14/484,103

(22) Filed: Sep. 11, 2014

Related U.S. Application Data
(63) Continuation of application No. 13/106,520, filed on May 12, 2011.
(60) Provisional application No. 61/345,519, filed on May 17, 2010.

(51) Int. Cl. G06Q 20/10

(52) U.S. Cl. CPC G06Q 20/102; G06Q 40/02
USPC 705/40

(57) ABSTRACT

A system for collection comprises a processor and a memory. The processor is configured to determine that a collector is willing to assume a financial obligation for a collectee and to determine whether the collectee has funds to repay the obligation at a financial institution. The processor is further configured to transfer the funds from the financial institution associated with the collector for repayment of the financial obligation in the event that the collectee has funds to repay the obligation at the financial institution. A memory coupled to the processor and configured to provide the processor with instructions.

### CROSS REFERENCE TO OTHER APPLICATIONS

This application is a continuation of co-pending U.S. patent application Ser. No. 13/106,520, entitled SYSTEM FOR COLLECTORLESS COLLECTIONS filed May 12, 2011 which is incorporated herein by reference for all purposes, which claims priority to U.S. Provisional Application No. 61/345,519, entitled SYSTEM FOR COLLECTORLESS COLLECTIONS filed May 17, 2010 which is incorporated herein by reference for all purposes.

### BACKGROUND OF THE INVENTION

Consumers and businesses (the ‘collectee’) are constantly faced with cash flow issues where current deposits don't match obligations due. In these environments, collectors must continually engage with the collectee until payment is made. The costs and time for a collector to get paid can be substantial.

### BRIEF DESCRIPTION OF THE DRAWINGS

Various embodiments of the invention are disclosed in the following detailed description and the accompanying drawings.

FIG. 1 is a block diagram illustrating an embodiment of a system for collections.

FIG. 2 is a block diagram illustrating an embodiment of a system for collection.

FIG. 3 is a flow diagram illustrating an embodiment of a process for collections.

FIG. 4 is a flow diagram illustrating an embodiment of a process for applying for a loan for a product or service.

FIG. 5 is a flow diagram illustrating an embodiment of a process for loan approval.

FIG. 6 is a flow diagram illustrating an embodiment of a process for determining whether repayment funds are available.

FIGS. 7A, 7B, and 7C are a flow diagram illustrating an embodiment of a process for collections.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for collection is disclosed. The system comprises a processor and a memory. The processor is configured to determine that a collector is willing to assume a financial obligation for a collectee. The processor is further configured to determine whether the collectee has funds to repay the obligation at a financial institution. The processor is further configured to transfer the funds from the financial institution associated with the collector for repayment of the financial obligation in the event that the collectee has funds to repay the obligation at the financial institution. The memory is coupled to the processor and configured to provide the processor with instructions.

A collectorless collections system is disclosed. The system continually (as frequently as collector deems necessary) and automatically monitors cash flow of a collectee and debits funds when cash is available. The system comprises a service that uses a platform that gathers a collectee's available financial instruments during the application process in order to be able to repay an obligation. Beyond collecting the appropriate debit information (i.e., bank routing and account number) the system collects the collectee's credentials to the financial instrument which will provide real-time updates on balance and transactions (e.g., cash flow). This enables a collections process that avoids engaging the collectee (e.g., in the event that prior consent was given by the collectee, as with the providing of the collectee's credentials). In some embodiments, the collectee may also be tied to a 3^{rd} party service that the collectee owns (e.g., email, phone, cellular, cable, utility etc.) which may be temporarily suspended by the collector if repayment is overdue. In other embodiments, the collectee may be required by the system to provide a 3^{rd} party to electronically co-sign the loan. The co-signer may be required to provide their own repayment information (i.e., bank routing and account number) that will be used for repayment in the case of delinquency by the collectee. The co-signer may also be required to provide credentials (e.g., bank user ID and password) to their own financial instruments so the system can verify the co-signers cash flow.

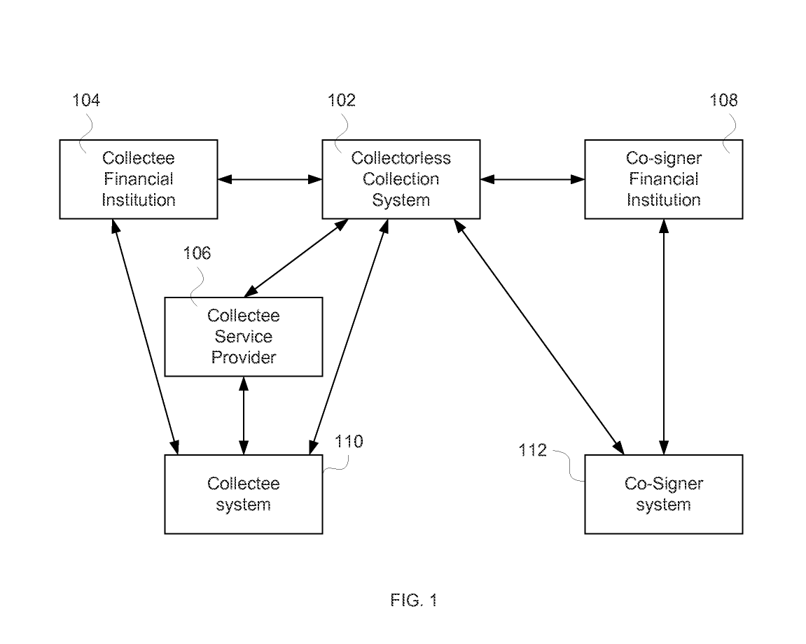

FIG. 1 is a block diagram illustrating an embodiment of a system for collections. In the example shown, collectee using collectee system 110 applies to obtain a service or a product and further applies to pay for the service or product at a later time. Collectorless collection system 102 receives information from collectee to determine whether to a collector is willing to assume a financial obligation for the collectee. For example, the collectee provides login and password information to a bank or other financial institution that enables collectorless collection system 102 to access collectee's accounts. Collectorless collection system 102 to determine deposits, withdrawals, balances, or in other words cash flows to determine whether the collectee will be able to repay. In addition, when the collectee is due to repay the financial obligation, collectorless collection system 102 is able to access accounts of the collectee to transfer repayment(s) from collectee financial institution 104. In some embodiments, collectee service provider 106 is contacted by collectorless collection system 102 to suspend or terminate service in the event that collectorless collection system 102 is unable to collect repayment from collectee financial institution 104. In some embodiments, co-signer financial institution 108 is contacted by collectorless collection system 102 to collect repayment from in the event that collectorless collection system 102 is unable to collect repayment from collectee financial institution 104. In some embodiments, a co-signer using co-signer system 112 provides access information (e.g., a login and password) information to a collector using collectorless collection system 102.

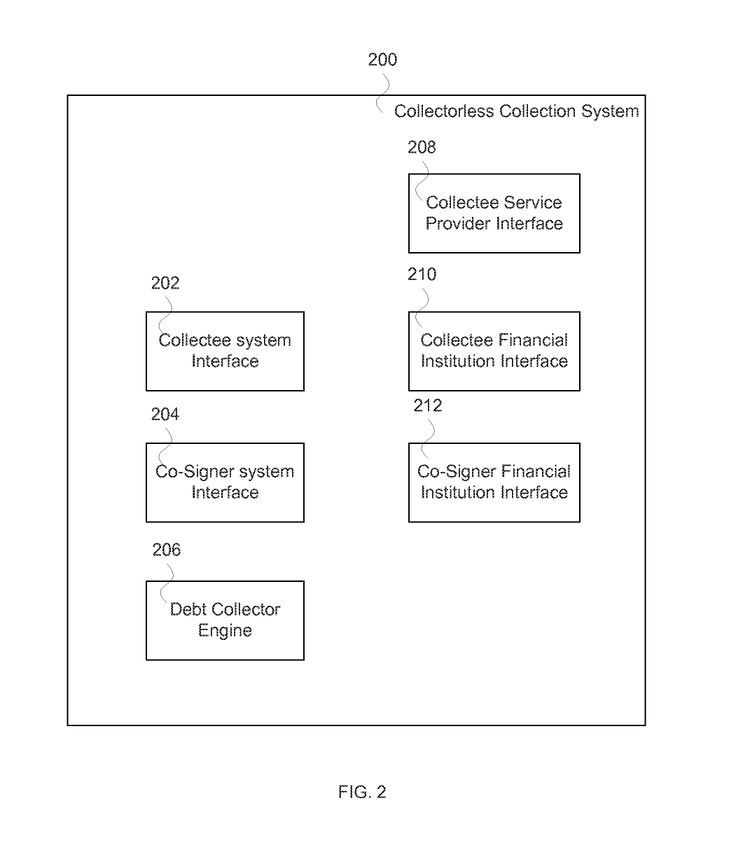

FIG. 2 is a block diagram illustrating an embodiment of a system for collection. In some embodiments, collectorless collection system 200 is used to implement collectorless collection system 102. In the example shown, collectorless collection system 200 comprises collectee interface 202, co-signer interface 204, debt collector engine 206, collectee service provider interface 208, collectee financial institution interface 210, and co-signer financial institution interface 212. Collectee system interface 202 enables collectorless collection system 200 to receive information regarding a financial obligation collector is determining whether to assume for collectee. Collectee system interface 202 also receives information regarding collectee financial institution (e.g., access information to one or more accounts at a bank or financial institution). Collectee system interface 202 also receives information regarding collectee co-signer (e.g., a person willing to provide access information to one or more accounts to potentially repay the financial obligation of collectee in the event that the collectee is unable to repay by access to a collectee account). Collectee system interface 202 also receives information regarding collectee service provider (e.g., so that the collector can suspend or terminate service for collectee in order to persuade the collectee of the importance of repaying collector the financial obligation).

Co-signer system interface 204 enables collectorless collection system 200 to access one or more accounts of a co-signer to allow collector to collect repayment in the event that the collectee fails to repay a financial obligation or have sufficient funds to repay a financial obligation in an account.

Debt collector engine 206 determines whether to take on a debt of a collectee by looking at cash flows in an account that collectee has provided access to. Debt collector engine 206, for example, examines the cash flow in and out of one or more accounts to see if there is likely a time when collector can transfer repayment out of the one or more accounts. In some embodiments, the transfer is timed so that no insufficient funds fees or minimum balance fees are experienced by collectee. Debt collector engine is also able to turn off service of a service provider (e.g., cell phone, utility such as gas, power, water, electric cable service, etc.) to a collectee. Debt collector engine can also transfer repayment from a co-signer account.

Collectee service provider interface 208 enables collectorless collection system 200 to communicate with a service provider to stop collectee from getting service if the collectee has not repaid loan that the collector made to collectee.

Collectee financial institution interface 210 enables collectorless collection system 200 to communicate with a financial institution of the collectee in order to transfer money out of the collectee account to repay a loan that the collector made to collectee.

Cosigner financial institution interface 212 enables collectorless collection system 200 to communicate with a financial institution of a co-signer in order to transfer money out of the co-signer account to repay a loan that the collector made to collectee.

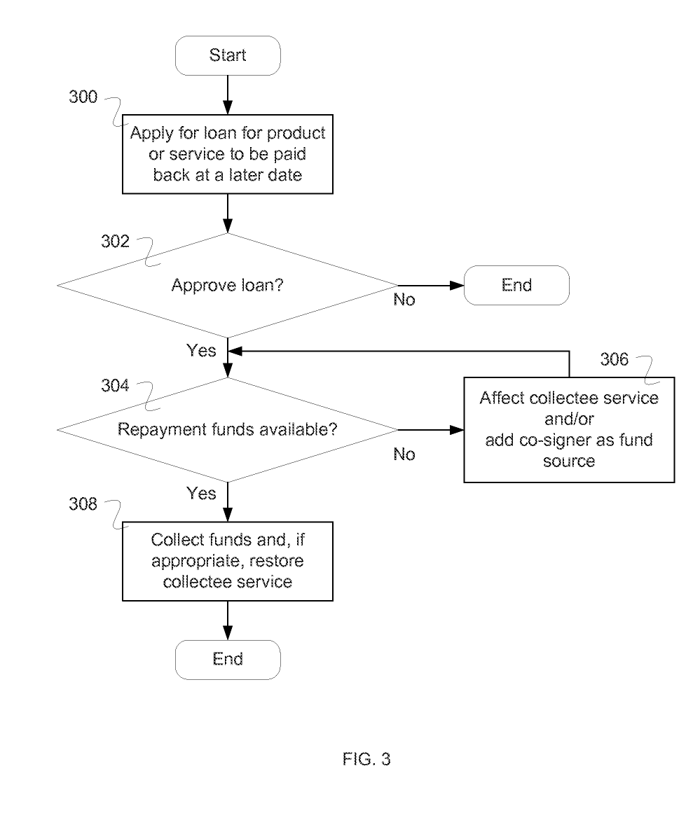

FIG. 3 is a flow diagram illustrating an embodiment of a process for collections. In some embodiments, the process of FIG. 3 is executed by collectorless collection system 200 of FIG. 2 or collectorless collection system 102 of FIG. 1. In the example shown, in 300 a loan for a product or service is applied for to be paid back at a later date. In 302, it is determined whether an approval is received for a loan. In the event that the loan is not approved, the process ends. In the event that the loan is approved, in 304 it is determined whether repayment funds are available. In the event that repayment funds are not available, in 306 a collectee service is affected and/or a co-signer is added as a fund source for repayments and control is transferred to 304. In the event that repayment funds are available, in 308 funds are collected and, if appropriate, collectee service is restored.

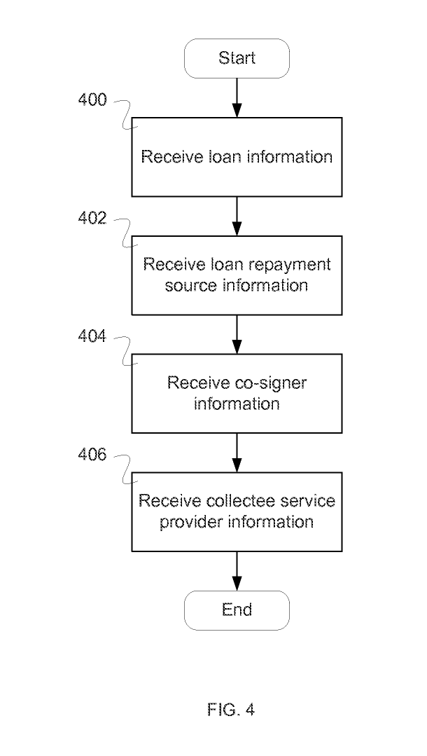

FIG. 4 is a flow diagram illustrating an embodiment of a process for applying for a loan for a product or service. In some embodiments, the process of FIG. 4 is used to implement 300 of FIG. 3. In the example shown, in 400 loan information is received. For example, amount of loan, reason for loan, service or product that the loan is associated with are received. In 402, loan repayment source information is received. For example, account information, account access information such as user identification and password, etc. In 404, co-signer information is received. For example, account information, account access information such as user identification and password, etc. In 406, collectee service provider information is received. For example, account information and service provider information such as company name, address, etc.

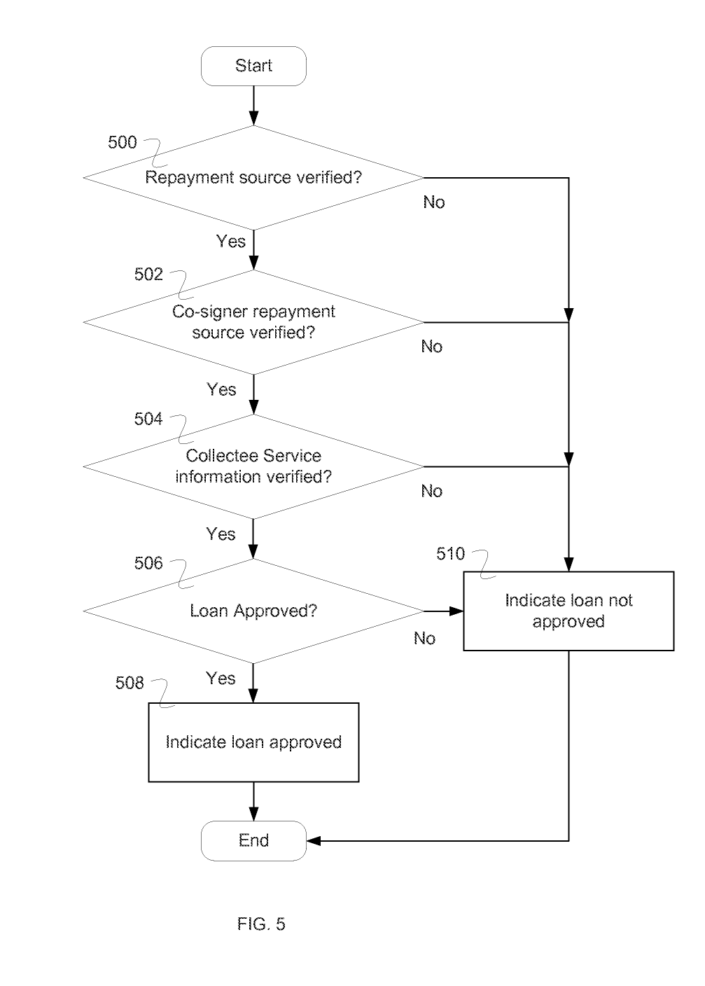

FIG. 5 is a flow diagram illustrating an embodiment of a process for loan approval. In some embodiments, the process of FIG. 5 is used to implement 302 of FIG. 3. In the example shown, in 500, it is determined whether the repayment source is verified. In the event that repayment source is not verified, control is transferred to 510, where it is indicated that the loan is not approved and the process ends. In the event that the repayment source is verified, it is determined in 502 of the co-signer repayment source is verified. In the event that co-signer repayment source is not verified, control is transferred to 510, where it is indicated that the loan is not approved and the process ends. In the event that the co-signer repayment source is verified, it is determined in 504 collectee service information is verified. In the event that collectee service information is not verified, control is transferred to 510, where it is indicated that the loan is not approved and the process ends. In the event that collectee service information is verified, in 506 it is determined whether the loan is approved. In the event that the loan is not approved, in 510 it is indicated that the loan is not approved and the process ends. In the event that the loan is approved, it is indicated in 508 that the loan is approved and the process ends.

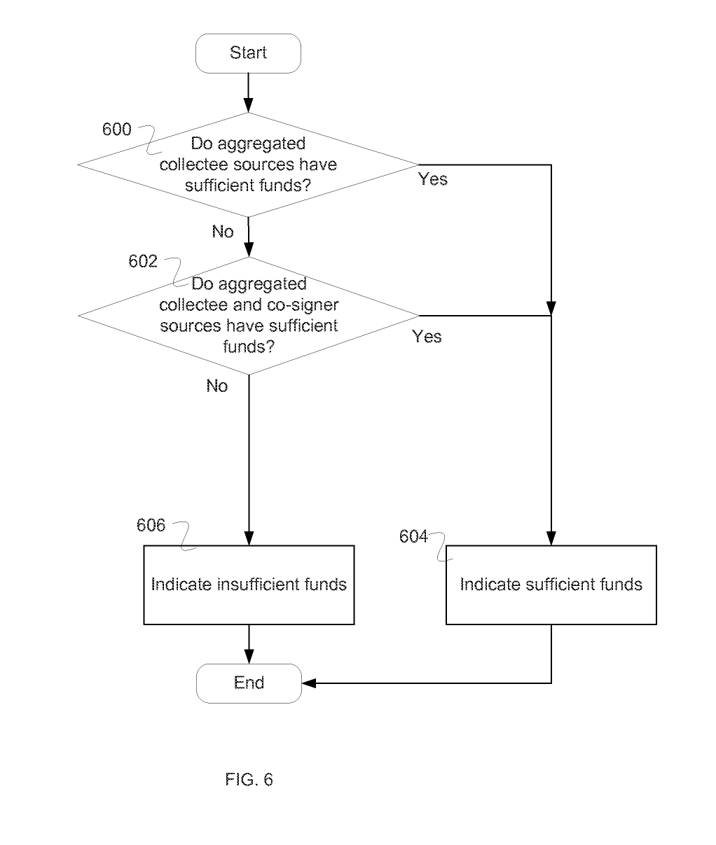

FIG. 6 is a flow diagram illustrating an embodiment of a process for determining whether repayment funds are available. In some embodiments, the process of FIG. 6 is used to implement 304 of FIG. 3. In the example shown, in 600 it is determined whether the aggregated collectee sources have sufficient funds. For example, one or more account balances are accessed to determine whether sufficient funds are available in aggregate (e.g., summed altogether or partially to see if whether from one or more than one of the accounts if a loan can be repaid) to repay the financial obligation. In the event that the aggregated collectee sources have sufficient funds, it is indicated in 604 that there are sufficient funds and the process ends. In the event that there are not sufficient funds in the aggregated collectee sources then, in 602 it is determined whether there are sufficient funds in the aggregated collectee and co-signer sources. In the event that the aggregated collectee and co-signer sources have sufficient funds, then in 604 it is indicated in 604 that there are sufficient funds and the process ends. In the event that there are not sufficient funds in the aggregated collectee and co-signer sources, then in 606 it is indicated that there are not sufficient funds and the process ends.

In some embodiments, there is a waiting period and the collectee and/or co-signer account(s) are re-accessed to determine if there are funds sufficient for full or partial payment. In some embodiments, partial payment is taken and a waiting period is waited to see if the remainder of the repayment can be taken. In some embodiments, it is determined if a fee would be assessed to the collectee in the event that the repayment (either partial or full) is taken or transferred from the account and in the event that a fee would be assessed (e.g., a low balance fee, an insufficient funds fee, a transaction fee, or any other appropriate fee), then the account is left alone and no repayment is taken.

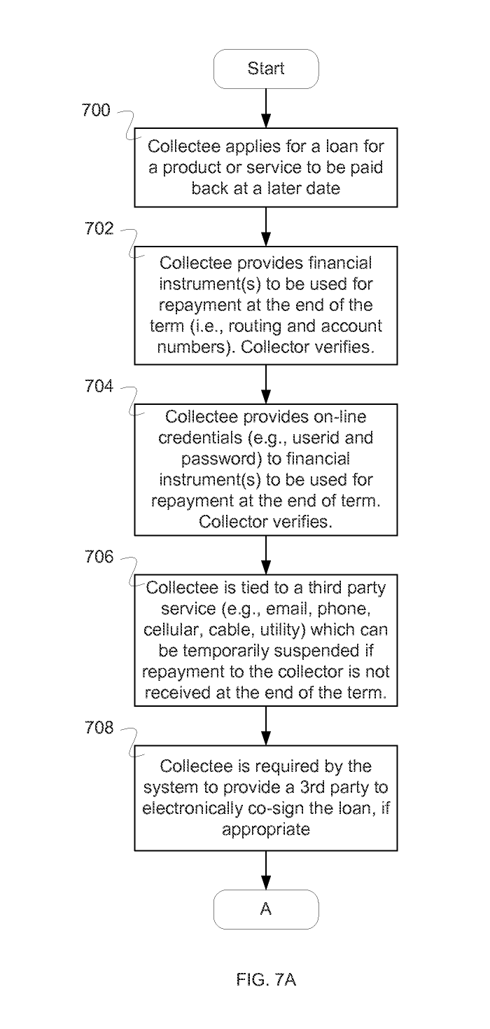

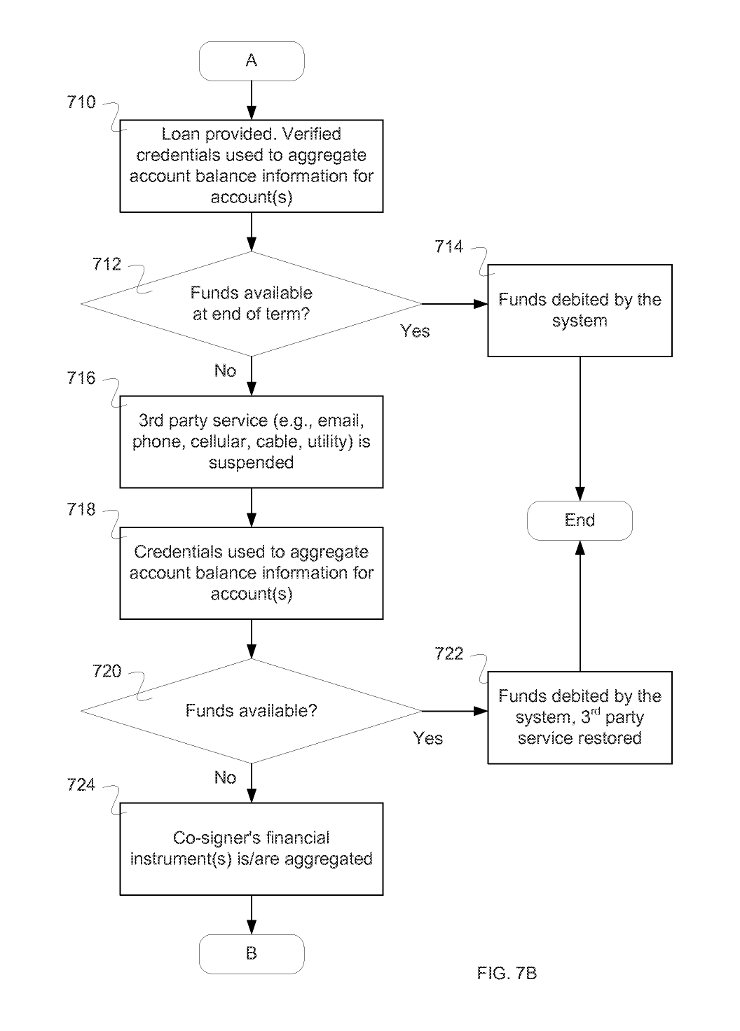

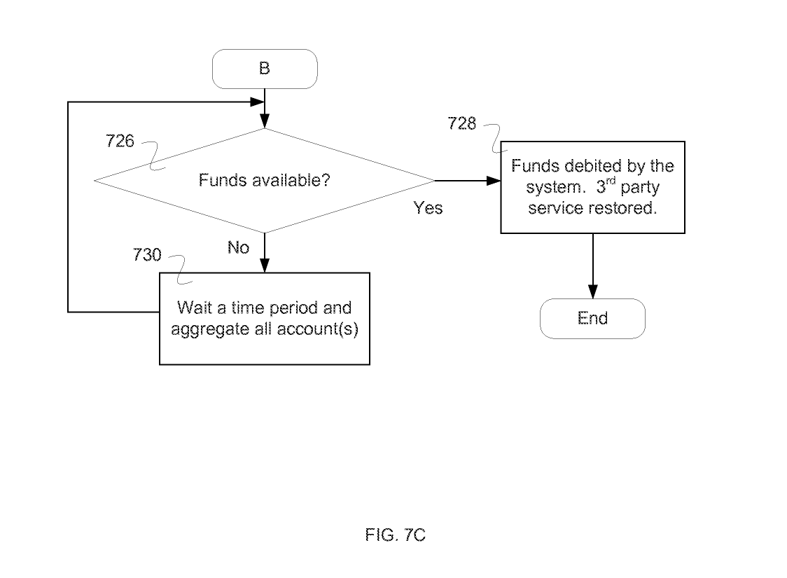

FIGS. 7A, 7B, and 7C are a flow diagram illustrating an embodiment of a process for collections. In the example shown, in 700 the collectee applies for a loan for a product or a service that is to be paid back at later date. In 702, the collectee provides their financial instrument(s) to be used for repayment at the end of the term (e.g.,., a bank routing and an account number). The system verifies the financial instruments. In some embodiments, there are several financial instruments and their debit priority varies (e.g., a primary source, a secondary source, etc.).

In 704, the collectee provides the online credentials (e.g., user ID & password) to their designated financial instrument(s) to be used for repayment at the end of the term. The system verifies the information. For example, the system validates the financial instrument credentials and verifies balance and transaction information (e.g., cash flow analysis).

In 706, the collectee is tied to a third party service (e.g., email, phone, cellular, cable, utility) which can be temporarily suspended if repayment to the collector is not received at the end of the term. The collector's ability to disable the collectee's service may or may not require the agreement of the 3^{rd} party service provider.

In 708, the collectee is required by the system to provide a 3^{rd} party to electronically co-sign the loan, if appropriate. The co-signer is required to provide his or her own repayment information (e.g., bank routing and account number) that is used for repayment in the case of delinquency by the collectee. The co-signer is required to provide credentials (e.g., bank userid and password) to their own financial instruments so the system can verify the co-signers cash flow. In some embodiments, a co-signer is not required in the event that the collectee has qualified as a good risk.

In 710, a loan is provided to the collectee, and the system aggregates account balance information for the collectees account(s). In 712, upon the due date for obligation, it is determined whether funds are available at the end of the term of the loan. For example, the system utilizes the collectee's financial institution information and online credentials to verify funds availability for the obligation.

In the event that funds are available, in 714 the funds are debited by the system and the process ends

In the event that funds are not available, in 716 the system suspends the 3^{rd} party service that the collectee provided rights to suspend during the application process.

In 718, credentials used to aggregate account balance information for account(s). For example, the system begins to continually and automatically aggregate the collectee's account balance data again. In 720, it is determined whether funds are available. In some embodiments, the determination is made after the obligation is past due.

In the event that funds are available, in 722 the funds are debited by the system and the collectee's 3^{rd} party service is restored and the process ends

In the event that funds are not available, in 724 the co-signer instrument(s) is/are aggregated.

In 726, it is determined whether there are sufficient funds in the aggregated co-signer accounts.

In the event that there are sufficient funds, then in 728 funds are debited and 3^{rd} party service is restored.

In the event that there are insufficient funds, then in 730 a period of time is waited and all account(s) are aggregated (e.g., from the collectee and the co-signer) and control passes to 726.

In some embodiments, the system automatically collects on a debt after a loan repayment time has been exceeded. Financial instrument(s) will continually be aggregated to determine when funds are available that are sufficient to meet the obligation (e.g., the repayment of the debt). Once the funds are verified the system debits the amount from the appropriate financial instrument. The system may debit partial funds or full funds depending on the consumer agreement and business model. The automatic collection on the debt avoids the standard collections process that entails heavy employee or third party vendor collections staffing to continually call, email, and mail a consumer who has not repaid a loan. The system's automatic collection also prevents a consumer from paying unnecessary insufficient funds charges in that a debt is only collected in the event that funds are available. In contrast, a typical automatic deduction from an account does not check for insufficient funds and in the event that funds are not available, the consumer will be charged an insufficient funds charge and/or an overdraft charge.

In some embodiments, the system automatically collects on a debt from a co-signer after a loan repayment time has been exceeded. Financial instrument(s) will continually be monitored to determine when funds are available that are sufficient to meet the obligation (e.g., the repayment of the debt). Once the funds are verified the system debits the amount from the appropriate financial instrument. The system may debit partial funds or full funds depending on the consumer agreement and business model as guided by a collector rule set. In the event that funds are available, the funds are debited by the system and the collectee' s 3^{rd} party service is restored.

In some embodiments, the automatic collection on a debt continues until funds have been collected or as guided by a collector rule set that must remain in compliance with regulatory rules governing fair lending and fair collections practices.

Although the foregoing embodiments have been described in some detail for purposes of clarity of understanding, the invention is not limited to the details provided. There are many alternative ways of implementing the invention. The disclosed embodiments are illustrative and not restrictive.

1. A system for collection, comprising:
a processor configured to:
determine that a collector is willing to assume a financial obligation for a collectee;
determine whether the collectee has funds to repay the obligation at a financial institution;
in the event that the collectee has funds to repay the obligation at the financial institution, transfer the funds from the financial institution associated with the collector for repayment of the financial obligation; and
a memory coupled to the processor and configured to provide the processor with instructions.

2. A system as in claim 1, wherein the processor is further configured to receive a banking credential from the collectee allowing access to the financial institution.

3. A system as in claim 2, wherein access comprises access to a balance in one or more accounts.

4. A system as in claim 2, wherein access comprises access to a deposit in one or more accounts.

5. A system as in claim 2, wherein access comprises access to withdrawals in one or more accounts.

6. A system as in claim 2, wherein access comprises access to transfer from one or more accounts to a collector account.

7. A system as in claim 1, wherein the funds comprises aggregated funds available in one or more accounts associated with the collectee.

8. A system as in claim 1, wherein the funds comprises aggregated funds available in one or more accounts associated with a co-signer.

9. A system as in claim 1, wherein the funds comprises aggregated funds available in one or more accounts associated with the collectee and one or more accounts associated with the co-signer.

10. A system as in claim 1, wherein the processor is further configured to indicate an inability to pay the financial obligation to a service provider for the collectee in the event that the collectee does not have funds to repay the obligation at the financial institution.

11. A system as in claim 1, wherein the financial institution comprises a bank.

12. A system as in claim 1, wherein the financial obligation comprises a loan.

13. A system as in claim 1, wherein the financial obligation is for a service provided.

14. A system as in claim 1, where repayment funds to repay the obligation at the financial institution comprises a partial payment for the obligation.

15. A system as in claim 1, wherein the repayment funds to repay the obligation at the financial institution comprise a full payment for the obligation.

16. A system as in claim 1, wherein determining that the collectee has funds to repay comprises determining that the collectee in the event that a transfer takes place has sufficient funds to avoid an insufficient funds fee.

17. A system as in claim 1, wherein determining that the collectee has funds to repay comprises the determination that the collectee in the event that a transfer takes place has sufficient funds to avoid a low balance fee.

18. A method for collection, comprising:
determining that a collector is willing to assume a financial obligation for a collectee;
determining whether the collectee has funds to repay the obligation at a financial institution;
in the event that the collectee has funds to repay the obligation at the financial institution, transferring the funds from the financial institution associated with the collector for repayment of the financial obligation; and

19. A computer program product for collection, the computer program product being embodied in a computer readable storage medium and comprising computer instructions for:
determining that a collector is willing to assume a financial obligation for a collectee;
determining whether the collectee has funds to repay the obligation at a financial institution;
in the event that the collectee has funds to repay the obligation at the financial institution, transferring the funds from the financial institution associated with the collector for repayment of the financial obligation.
